(19) United States
(12) Patent Application Publication
(10) Pub. No.: US 2006/0119872 A1
(43) Pub. Date: Jun. 8, 2006

(54) Printing processing system

(75) Inventor: Shinji Koizumi, Shizuoka-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/004,800

(22) Filed: Dec. 7, 2004

(51) Int. Cl. G06K 15/00

(52) U.S. Cl. 358/1.13; 358/1.16

(57) ABSTRACT

The present invention provides a printing processing system in which, in case there is a printer driver corresponding to a print file to be printed out which is stored in a connected detachable memory, the print file is converted by the printer driver, while in case there is no corresponding printer driver, the print file is transmitted to a server having a corresponding printer driver, and converted print data is received to be printed out, which always makes it possible to print out a print file.

### BACKGROUND OF THE INVENTION

1. Field of the Invention

The present invention relates to a printing processing apparatus, a printing processing system to which the printing processing apparatus is connected through a network, and a printing control method in the printing processing system.

2. Description of the Related Art

There is disclosed a printing system to be described as follows in Japanese Patent Application Laid-Open Publication No. 2003-196055. The printing system is a system in which a server having an application, a client computer and a printer are connected through a network. When receiving a printing request to print out application data from a user, the client computer sends the printing request to the server together with client information. The server starts up a printer driver based on the client information to generate print data, and sends thus generated print data to the client computer or the printer to print out the print data.

In the system, there is a problem that the efficiency is reduced since all the print data is once sent to the server through the network.

On the other hand, there is known a system in which a solid-state memory such as a USB flash memory is directly connected to an individual printing processing apparatus, and the stored print data is directly printed out without using a computer. In the system, there is a possibility that print data of some kinds cannot be printed out. In this case, conventionally, the solid-state memory has to be once connected to a personal computer etc., and the print data is converted into printable print raster image data using a corresponding printer driver, and then converted data is sent to the printing processing apparatus or a printer to be printed out thereby, which requires a troublesome work.

### BRIEF SUMMARY OF THE INVENTION

According to embodiments of the present invention, an object of the present invention is to provide a printing processing system, a printing processing apparatus, and a printing control method in the printing processing system, which can effectively print out print data sent from a memory.

The present invention may provide a printing processing system, comprising:

a printing processing apparatus that has:

(a) a printer driver for converting a print file to be printed out which is written by a certain application software into a printable format;

(b) a printability judgment unit for, when a detachable memory having stored therein the print file is connected, judging whether or not the print file can be converted into a printable format by the printer driver;

(c) a first print format conversion unit for, when it is judged that the print file can be converted into a printable format by the printability judgment unit, converting the print file into converted print data of printable format using the printer driver;

(d) a printing unit for printing out the converted print data whose format is converted into printable format by the first print format conversion unit; and

(e) a print file transmission unit for, when it is judged that the print file cannot be converted into a printable format by the printability judgment unit, transmitting the print file, and

a printing processing server that has:

(f) a print file reception unit for receiving the print file that is transmitted from the print file transmission unit of the printing processing apparatus;

(g) a second print format conversion unit for converting the print file that is received by the print file reception unit into converted print data using a printer driver that can convert the print file into a printable format; and

(h) a transmission unit for transmitting the converted print data which is converted into a printable format by the second print format conversion unit to the printing processing apparatus.

The present invention may provide a printing control method in the printing processing system, comprising:

a printability judgment step of, when a memory having stored therein a print file to be printed out is connected, judging whether or not the print file can be converted into a printable format by a printer driver that converts a print file which is written by a certain application software into a printable format;

a print format conversion step of, when it is judged that the print file can be converted into a printable format in the printability judgment step, converting the print file into converted print data of printable format using the printer driver;

a transmission/reception step of, when it is judged that the print file cannot be converted into a printable format in the printability judgment step, transmitting the print file to a printing processing server having a printer driver that can convert the print file into a printable format, and receiving converted print data that is converted into the printable format by the printing processing server; and

a printing step of printing out the converted print data that is converted into the printable format in the transmission/reception step or the print format conversion step.

### BRIEF DESCRIPTION OF THE DRAWINGS

Further objects and advantages of the invention can be more fully understood from the following detailed description taken in conjunction with the accompanying drawings, in which:

FIG. 1 shows the configuration of a printing processing apparatus of a printing processing system according to an embodiment of the present invention;

FIG. 2 shows the configuration of a printing processing server of the printing processing system;

FIG. 3 is a flow chart for explaining the operation of the printing processing system according to the embodiment of the present invention; and

FIG. 4 is a flow chart for explaining the operation of the printing processing system.

### DETAILED DESCRIPTION OF THE INVENTION

The printing processing system according to an embodiment of the present invention will be described below with reference to the accompanying drawings. In the present invention, file (print file) data that is formed by a certain application software and is wanted to be printed out is referred to as application print data, data that is converted by a printer driver and is described in a printer description language is referred to as printer description data or converted print data, and data that is converted by a spooler is referred to as print raster image data, which will be distinguished.

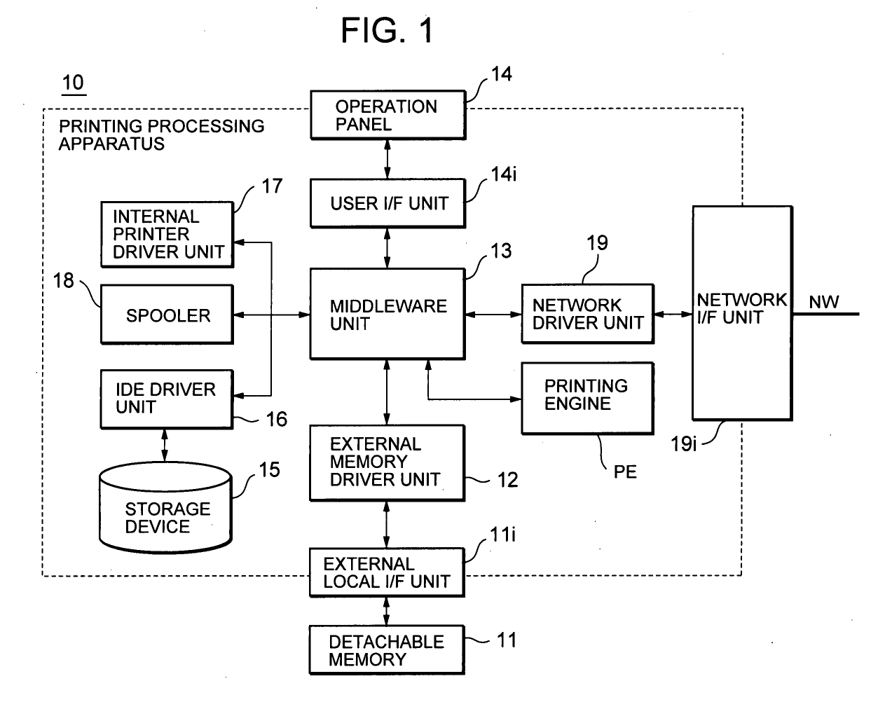

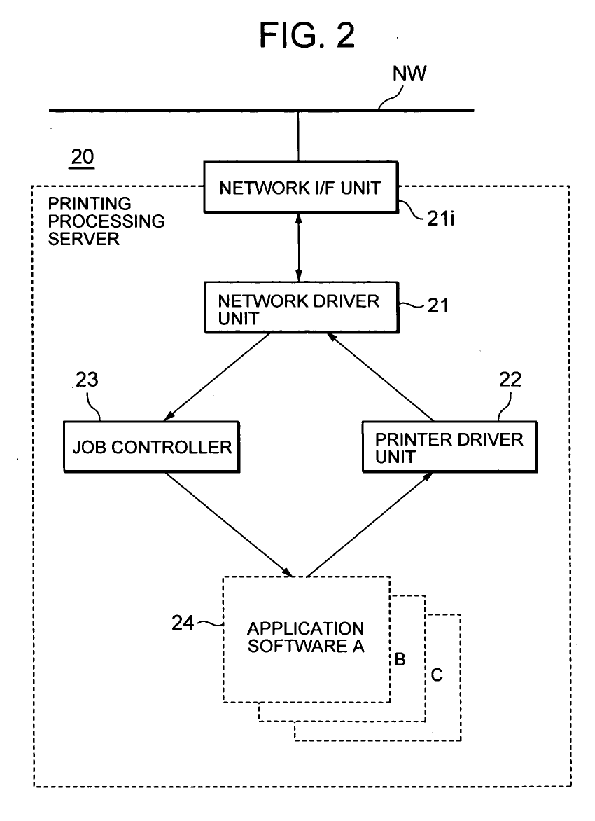

The printing processing system in the embodiment includes a printing processing apparatus being a digital complex machine or MFP (multi function peripherals), and a printing processing server that is connected to the printing processing apparatus through a network such as a LAN (local area network) FIG. 1 shows the configuration of a printing processing apparatus 10 of the printing processing system in the embodiment, while FIG. 2 shows the configuration of a printing processing server 20.

The printing processing apparatus 10 includes an external local interface (I/F) unit 11i that performs interface processing with a detachable memory 11 such as a USB memory, which can be detachably connected to the printing processing apparatus 10, when the memory is installed thereto, an external memory driver unit 12 that is connected to the external local I/F unit 11i, a middleware unit 13 that is connected to the external memory driver unit 12 and controls the whole printing processing apparatus 10, an operation panel 14 that is operated by an operator, a user interface (I/F) unit 14i that is connected to the operation panel 14 and the middleware unit 13, a storage device 15 such as an HDD (hard disc drive), an IDE driver unit 16 for driving and controlling the storage device 15, an internal printer driver unit 17 that stores a printer driver used to describe application print data sent from the detachable memory 11 in a printer description language, a spooler 18 that converts printer description data into print raster image data, a network driver unit 19 that is connected to the middleware unit 13, a network interface (I/F) unit 19i that is connected to the network driver unit 19 and a network NW which is connected to the printing processing apparatus 10, and a printing engine PE for printing, as shown in FIG. 1.

In case the detachable memory 11 is a USB memory, the external local I/F unit 11i is a USB connector. The operation panel 14 has a display unit for displaying images and an input unit through which control signals are input by an operator using keys.

The printing processing server 20 that is connected to the network NW includes a network driver unit 21, a network interface (I/F) unit 21i that is arranged between the network driver unit 21 and the network NW, a printer driver unit 22, a job controller 23, and an application unit 24 having stored therein an application software, as shown in FIG. 2.

When sending data to the network NW, the network driver units 19, 21 make the data format appropriate for transmission, and process data at the time of transmitting and receiving data.

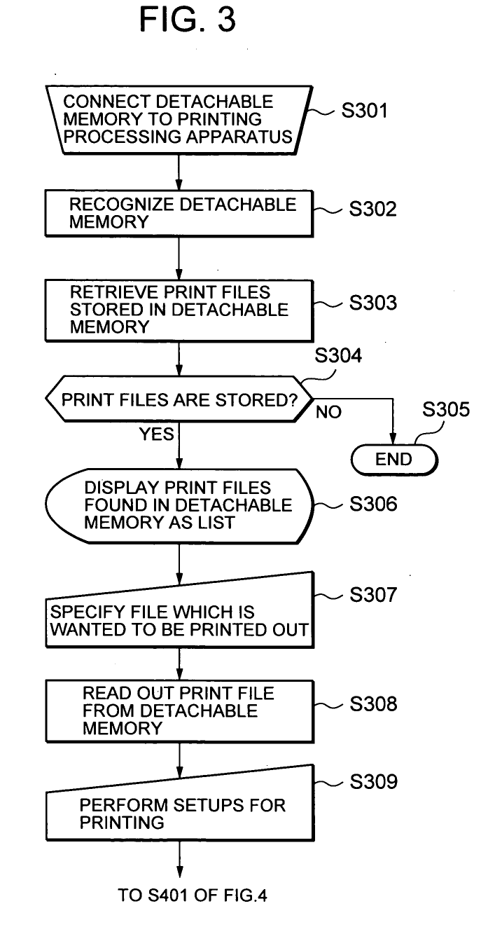

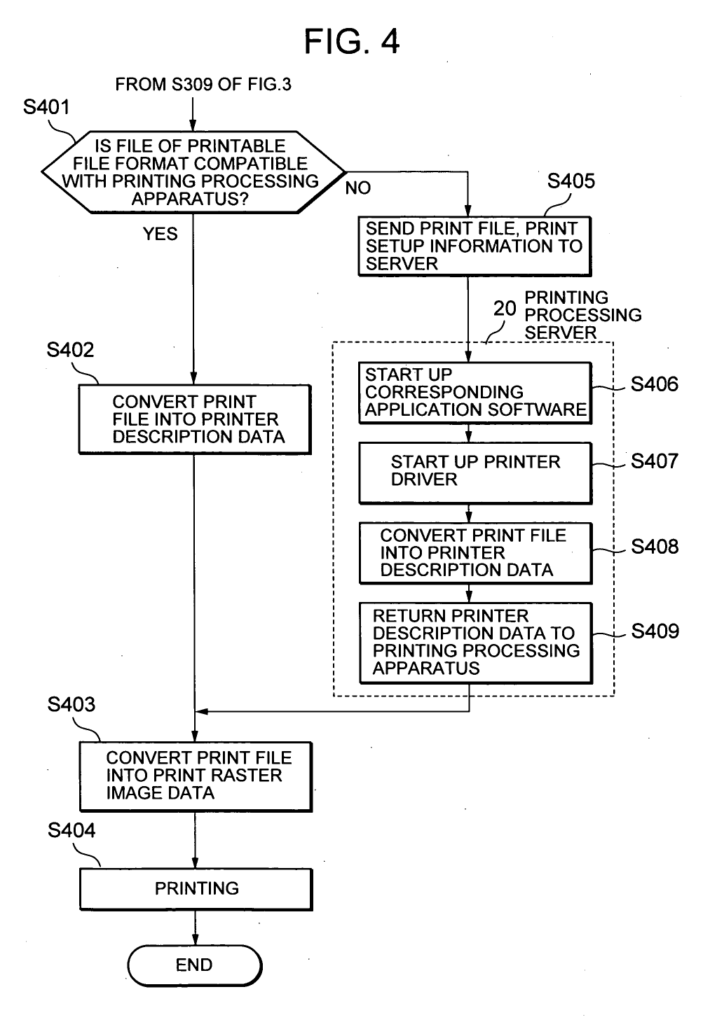

Next, the operation of this embodiment of the present invention will be explained with reference to drawings. FIG. 3 and FIG. 4 show flow charts for explaining the operation of the printing processing apparatus 10 and the printing processing server 20.

Firstly, in step S301, the detachable memory 11 having stored therein a file which is written by a predetermined application software and is wanted to be printed out is connected to the external local I/F unit 11i of the printing processing apparatus 10. It is recognized by the middleware unit 13 through the external local I/F unit 11i and the external memory driver unit 12 that the detachable memory 11 is connected (step S302). Then, in step S303, the middleware unit 13 retrieves print files stored in the detachable memory 11.

In step S304, it is judged whether or not print files are stored. In case print files are not found, the middleware unit 13 makes the operation panel 14 display that there is no print file on the screen of the display unit, going to step S305 to terminate the processing.

On the other hand, in step S304, in case one or more print files are found, then in step S306, print files found in the detachable memory 11 which are retrieved in step S303 are displayed on the display unit of the operation panel 14 of the printing processing apparatus 10 as a list.

In step S307, of the print files in the list displayed on the screen of the display unit of the operation panel 14, the operator specifies a file that the operator wants to print out. The operator specifies the file wanted to be printed out by moving a cursor to the position of the print file on the screen to click it using a mouse. The operator's designation of the file to be printed out is recognized by the middleware unit 13 through the user I/F unit 14i.

In designating a file to be printed out, the operator can directly specify an application file stored in the detachable memory 11 through the operation panel 14. In case the operator fully knows about the contents of the detachable memory 11, he or she can specify the file to be printed out in a short period of time. Furthermore, files may be displayed on the operation panel 14 by a browser so as to specify the file wanted to be printed out on the screen of the browser.

Next, in step S308, the middleware unit 13 reads out an application file to be printed out from the detachable memory 11, and operates the IDE driver unit 16 to make the storage device 15 or a hard disc drive to store the application file. In step S309, the operator performs various setups to print out the application file or determines the print size, the number of copies, etc. of the print file through the operation panel 14. The print setup information, which are selected and input by the operator, is recognized by the middleware unit 13 through the user I/F unit 14i.

Next, in step S401, it is judged by the middleware unit 13 whether or not the file wanted to be printed out is of printable file format compatible with the printing processing apparatus 10, as shown in FIG. 4. The judgement on whether or not the file wanted to be printed out is printable is performed by judging whether or not the internal printer driver unit 17 of the printing processing apparatus 10 has a printer driver corresponding to the file. Specific judgement on whether or not the file is printable is performed by examining the extension of the print file.

In case the application file wanted to be printed out sent from the detachable memory 11 is of printable file format compatible with the printing processing apparatus 10, in step S402, a printer driver corresponding to the file format is read out from the internal printer driver unit 17, and the application file is converted into data that is described in a printer description language (printer description data) which is suited for the application software. The spooler 18 converts the print file into print raster image data that can be printed out by the printing processing apparatus 10 (step S403). Then, in step S403, the print raster image data is sent to the printing engine PE to be printed out.

On the other hand, in step S401, in case the selected print file is of unprintable file format incompatible with the printing processing apparatus 10, then in step S405, the print file is sent to the printing processing server 20 shown in FIG. 2 together with the various pieces of print setup information through the network NW.

The printing processing server 20 receives the print file together with the print setup information through the network I/F unit 21i, and sends the print file to the job controller 23 through the network driver unit 21. The job controller 23 detects an application software corresponding to the image format of thus sent print file from the application unit 24, and sends a printing instruction to start up the application software (step S406).

Next, in step S407, a printer driver corresponding to the application software is detected from the printer driver unit 22, and the print file is converted into printer description data (step S408). Then, thus converted printer description data is passed through the network driver unit 21 and the network I/F unit 21i, and returned to the printing processing apparatus 10 through the network NW (step S409).

The print file returned from the printing processing server 20 is sent to the middleware unit 13 through the network I/F unit 19i and the network driver unit 19, and is converted into print raster image data in the spooler 18 (step S403), and is then sent to the printing engine PE to be printed out at a printing unit, not shown (step S404).

In the above-described embodiment of the present invention, the printing engine PE is arranged in the printing processing apparatus 10, and printing processing is performed therein. However, the present invention is not restricted to this, and a printer may be connected to the printing processing apparatus 10 to print a print file thereby.

According to the above-described embodiment of the present invention, the internal printer driver unit 17 has to have merely a printer driver corresponding to an application software that is often used in the printing processing apparatus 10. Furthermore, in case the detachable memory 11 that stores a file which is written by an application software with no printer driver is connected to the printing processing apparatus 10, a print file is converted into printer description data suited for the print file in the printing processing server 20. Accordingly, irrespective of the kind of a print file stored in the detachable memory 11, printing processing is always possible, and print data which is written by a frequently-used application software can be printed out quickly comparatively.

The memory that is connected to the printing processing apparatus according to the present invention does not have to be a solid-state memory, and may be any memories that can store print files.

It goes without saying that various obvious modifications and simple variants come within the scope of the present invention beyond the above-described embodiment.

What is claimed is:

1. A printing processing system, comprising:
a printing processing apparatus that comprises:
(a) a printer driver for converting a print file to be printed out which is written by a certain application software into a printable format;
(b) a printability judgment unit for, when a detachable memory having stored therein the print file is connected, judging whether or not the print file can be converted into a printable format by the printer driver;
(c) a first print format conversion unit for, when it is judged that the print file can be converted into a printable format by the printability judgment unit, converting the print file into converted print data of printable format using the printer driver;
(d) a printing unit for printing out the converted print data whose format is converted into printable format by the first print format conversion unit; and
(e) a print file transmission unit for, when it is judged that the print file cannot be converted into a printable format by the printability judgment unit, transmitting the print file, and
a printing processing server that comprises:
(f) a print file reception unit for receiving the print file that is transmitted from the print file transmission unit of the printing processing apparatus;
(g) a second print format conversion unit for converting the print file that is received by the print file reception unit into converted print data using a printer driver that can convert the print file into a printable format; and
(h) a transmission unit for transmitting the converted print data which is converted into a printable format by the second print format conversion unit to the printing processing apparatus.

2. A system as set forth in claim 1, wherein the printing processing apparatus further comprises an operation panel for, when the memory is connected, displaying print files stored in the memory, and for, when at least one of the displayed print files is specified by an operator, inputting the specified print file as a print file to be printed out.

3. A printing processing apparatus, comprising:
a printer driver for converting a print file to be printed out which is written by a certain application software into a printable format; and
a print file conversion unit for judging whether or not the print file can be converted into a printable format by the printer driver, when a memory having stored therein a print file is connected, for converting the print file into a printable format using the printer driver, when it is judged that the print file can be converted into a printable format, and for transmitting the print file to a printing processing server having a printer driver that can convert the print file into a printable format, and receiving converted print data that is converted by the printing processing server when it is judged that the print file cannot be converted into a printable format.

4. An apparatus as set forth in claim 3, wherein the printing processing apparatus further comprises an operation panel for, when the memory is connected, displaying print files stored in the memory, and for, when at least one of the displayed print files is specified by an operator, inputting the specified print file as a print file to be printed out.

5. A printing processing apparatus, comprising:
a printer driver for converting a print file to be printed out which is written by a certain application software into a printable format;
a printability judgment unit for, when a memory having stored therein the print file is connected, judging whether or not the print file can be converted into a printable format by the printer driver;
a file conversion unit for, when it is judged that the print file can be converted into a printable format by the printability judgment unit, converting the print file into converted print data of printable format using the printer driver;
a printing unit for printing out the converted print data that is converted by the file conversion unit; and
a transmission/reception unit for, when it is judged that the print file cannot be converted into a printable format by the printability judgment unit, transmitting the print file to a printing processing server having a printer driver that can convert the print file into a printable format, and receiving converted print data that is converted by the printing processing server.

6. An apparatus as set forth in claim 5, wherein the printing processing apparatus further comprises an operation panel for, when the memory is connected, displaying print files stored in the memory, and for, when at least one of the displayed print files is specified by an operator, inputting the specified print file as a print file to be printed out.

7. A printing processing apparatus, comprising:
a printer driver for converting a print file to be printed out which is written by a certain application software into a printable format;
a file format judgment unit for, when a detachable memory having stored therein the print file is connected, detecting the file format of the print file stored in the memory and judging whether or not the print file of the detected file format can be converted into printer description data by the printer driver;
a print raster data conversion unit for, when it is judged that the print file can be converted into printer description data by the printer driver in the file format judgment unit, converting the print file into printer description data using the printer driver and further converting the converted printer description data into print raster data;
a printing unit for printing out the print raster data that is converted by the print raster data conversion unit;
a transmission/reception unit for, when it is judged that the print file cannot be converted into printer description data by the printer driver in the file format judgment unit, transmitting the print file to a printing processing server having a printer driver that can convert the print file into printer description data, and receiving printer description data that is converted by the printing processing server.

8. An apparatus as set forth in claim 7, wherein the printing processing apparatus further comprises an operation panel for, when the memory is connected, displaying print files stored in the memory, and for, when at least one of the displayed print files is specified by an operator, inputting the specified print file as a print file to be printed out.

9. An apparatus as set forth in claim 7, wherein the file format judgment unit performs the judgement based on the extension of the print file.

10. A printing control method in a printing processing system, comprising:
a printability judgment step of, when a memory having stored therein a print file to be printed out is connected, judging whether or not the print file can be converted into a printable format by a printer driver that converts a print file which is written by a certain application software into a printable format;
a print format conversion step of, when it is judged that the print file can be converted into a printable format in the printability judgment step, converting the print file into converted print data of printable format using the printer driver;
a transmission/reception step of, when it is judged that the print file cannot be converted into a printable format in the printability judgment step, transmitting the print file to a printing processing server having a printer driver that can convert the print file into a printable format, and receiving converted print data that is converted into the printable format by the printing processing server; and
a printing step of printing out the converted print data that is converted into the printable format in the transmission/reception step or the print format conversion step.

11. A printing control method in a printing processing system, comprising:
a printability judgment step of, when a detachable memory having stored therein a print file to be printed out is connected, judging whether or not the print file can be converted into a printable format by a printer driver that converts a print file which is written by a certain application software into a printable format;
a first print format conversion step of, when it is judged that the print file can be converted into a printable format in the printability judgment step, converting the print file into converted print data of printable format using the printer driver;
a print file transmission step of, when it is judged that the print file cannot be converted into a printable format in the printability judgment step, transmitting the print file to a printing processing server having a printer driver that can convert the print file into a printable format;
a second print format conversion step of converting the print file transmitted in the print file transmission step into converted print data of printable format using the printer driver of the printing processing server;
a transmission step of transmitting the converted print data that is converted into the printable format in the second print format conversion step from a transmission unit of the printing processing server;
a reception step of receiving the converted print data transmitted from the transmission unit using a reception unit of a printing processing apparatus; and
a printing step of printing out the converted print data that is converted into the printable format in the first print format step or the second print format conversion step.

12. A printing control method in a printing processing system, comprising:
a printability judgment step of, when a detachable memory having stored therein a print file to be printed out is connected, judging whether or not the print file can be converted into a printable format by a printer driver that converts a print file which is written by a certain application software into a printable format;
a first print data conversion step of, when it is judged that the print file can be converted into a printable format in the printability judgment step, converting the print file into printer description data of printable format using the printer driver;
a print file transmission step of, when it is judged that the print file cannot be converted into a printable format in the printability judgment step, transmitting the print file to a printing processing server having a printer driver that can convert the print file into a printable format;
a second print data conversion step of converting the print file transmitted in the print file transmission step into printer description data of printable format using the printer driver of the printing processing server;
a transmission step of transmitting the printer description data that is converted into the printable format in the second print data conversion step from a transmission unit of the printing processing server;
a reception step of receiving the printer description data transmitted from the transmission unit using a reception unit of a printing processing apparatus;
a print raster data conversion step of converting the printer description data that is converted in the first print data conversion step or the second print data conversion step into print raster data; and
a printing step of printing out the print raster data that is converted in the print raster data conversion step.
